(19) United States
(12) Patent Application Publication
(10) Pub. No.: US 2018/0294531 A1
(43) Pub. Date: Oct. 11, 2018

(54) METHOD OF PRODUCING ALL-SOLID BATTERY

(71) Applicant: TOYOTA JIDOSHA KABUSHIKI KAISHA, Toyota-shi (JP)

(72) Inventors: Kengo HAGA, Susono-shi (JP); Tomoya SUZUKI, Susono-shi (JP); Norihiro OSE, Shizuoka-ken (JP); Akiji HAYASHI, Toyota-shi (JP); Hiroyuki INOUE, Susono-shi (JP); Takayuki UCHIYAMA, Susono-shi (JP); Hajime HASEGAWA, Susono-shi (JP); Mitsutoshi OTAKI, Susono-shi (JP); Shigenori HAMA, Susono-shi (JP); Hiroyuki YAMAGUCHI, Susono-shi (JP); Dai KATO, Susono-shi (JP)

(73) Assignee: TOYOTA JIDOSHA KABUSHIKI KAISHA, Toyota-shi (JP)

(21) Appl. No.: 15/941,785

(22) Filed: Mar. 30, 2018

(30) Foreign Application Priority Data
Apr. 5, 2017 (JP) 2017-075581

(51) Int. Cl. H01M 10/0585; B32B 37/06; B32B 37/10; B32B 37/18; B32B 15/06; B32B 15/20; B32B 25/18; B32B 25/02; H01M 10/0525; H01M 10/0562; H01M 10/04

(52) U.S. Cl. CPC H01M 10/0585; H01M 2300/0091; B32B 37/10; B32B 37/182; B32B 15/06; B32B 15/20; B32B 25/18; B32B 25/02; H01M 10/0525; H01M 10/0562; H01M 10/0468; B32B 2307/202; B32B 2319/00; B32B 2457/10; B32B 2250/03; B32B 2255/06; B32B 2255/26; B32B 2264/107; B32B 2264/101; B32B 2315/08; B32B 2315/02; B32B 2311/24; B32B 2311/12; H01M 2300/0068; B32B 37/06

(57) ABSTRACT

A method of producing an all-solid battery includes pressing a laminate in a state where the laminate is insulated from a press machine. The laminate includes a negative electrode current collector layer, a negative electrode active material layer, a solid electrolyte layer, and a positive electrode active material layer. The negative electrode current collector layer includes copper, at least one of the negative electrode active material layer and the solid electrolyte layer includes a sulfide solid electrolyte, and the press machine is an anisotropic press machine.

### INCORPORATION BY REFERENCE

The disclosure of Japanese Patent Application No. 2017-075581 filed on Apr. 5, 2017 including the specification, drawings and abstract is incorporated herein by reference in its entirety.

### BACKGROUND

### 1. Technical Field

The present disclosure relates to a method of producing an all-solid battery.

### 2. Description of Related Art

For example, when an all-solid battery is produced, pressing a laminate including at least a positive electrode active material layer, a solid electrolyte layer, and a negative electrode active material layer is known.

For example, Japanese Unexamined Patent Application Publication No. 2015-125872 (JP 2015-125872 A) describes a method in which a laminate is obtained by forming a first electrode active material layer, a solid electrolyte layer, a second electrode active material layer, and a second current collector layer on both surfaces of a first current collector layer, and the laminate is pressed. An object of the technology in JP 2015-125872 A is to reduce the number of processes for preventing warpage of an all-solid battery laminate.

Japanese Unexamined Patent Application Publication No. 2012-256436 (JP 2012-256436 A) describes that, when an all-solid battery including a positive electrode current collector, a positive electrode active material layer, a solid electrolyte layer, a negative electrode active material layer, and a negative electrode current collector layer is produced, pressurization is performed while charging is performed. An object of the technology in JP 2012-256436 A is to prevent a current collector layer from being sulfurized during storage of the all-solid battery.

Japanese Unexamined Patent Application Publication No. 2015-162353 (JP 2015-162353 A) describes that, when an all-solid battery in which a positive electrode, a solid electrolyte layer, and a negative electrode whose area is larger than the positive electrode are laminated is produced, an insulator is disposed around the positive electrode and pressurization is performed. An object of the technology in JP 2015-162353 A is to prevent or reduce damage to an end of the all-solid battery laminate including electrodes with different areas.

It is known that, when an all-solid battery is produced, if a laminate including at least a positive electrode active material layer, a solid electrolyte layer, and a negative electrode active material layer is pressed, it is possible to improve an output and a capacity of the battery. For example, Japanese Unexamined Patent Application Publication No. 2011-142007 (JP 2011-142007 A) describes a method that includes a heating and pressing process in which a pressure is applied while heating a laminate when the laminate including a pair of electrodes and a solid electrolyte layer disposed between the pair of electrodes is produced.

### SUMMARY

When an all-solid battery is produced, if a laminate is pressed in order to improve an output and a capacity, a discharging capacity of the obtained all-solid battery may decrease. In particular, this phenomenon is significant when a negative electrode current collector layer contains copper and at least one of a negative electrode active material layer and a solid electrolyte layer contains a sulfide solid electrolyte.

The present disclosure provides a method of producing an all-solid battery. According to the method, even if pressing is performed on a laminate in which a negative electrode current collector layer contains copper and at least one of a negative electrode active material layer and a solid electrolyte layer contains a sulfide solid electrolyte, the all-solid battery in which a decrease in discharging capacity is prevented and an output and a capacity are improved is obtained.

A first aspect of the present disclosure relates to a method of producing an all-solid battery. The production method includes pressing a laminate in a state where the laminate is insulated from a press machine. The laminate includes a negative electrode current collector layer, a negative electrode active material layer, a solid electrolyte layer, and a positive electrode active material layer. The negative electrode current collector layer includes copper, at least one of the negative electrode active material layer and the solid electrolyte layer includes a sulfide solid electrolyte, and the press machine is an anisotropic press machine.

In the first aspect, the anisotropic press machine may be configured such that an applied pressure by the press machine varies according to a direction

In the first aspect, the negative electrode current collector layer may include a negative electrode active material layer non-laminating portion that projects in a direction along a first surface of the negative electrode current collector layer.

In the first aspect, the negative electrode current collector layer, the negative electrode active material layer, the solid electrolyte layer, and the positive electrode active material layer may respectively include a first surface, a second surface, a third surface, a fourth surface in a direction along the first surface. An area of the first surface may be largest in areas of the first surface, the second surface, the third surface, the fourth surface.

In the first aspect, the press machine may be a roll press machine.

In the first aspect, the press machine may be a surface press machine.

In the first aspect, the laminate may be pressed in a state where the laminate is heated.

In the first aspect, the laminate may include the negative electrode active material layer, the negative electrode current collector layer, the negative electrode active material layer, the solid electrolyte layer, and the positive electrode active material layer in this order.

In the first aspect, when the laminate is pressed, an insulating material may be disposed between the press machine and the laminate.

In the first aspect, the insulating material may be a sheet.

In the first aspect, the insulating material may be applied to a surface of the press machine that is in contact with the laminate.

In the first aspect, the insulating material may include at least one of an oxide-based insulating material, a carbide-based insulating material, a ceramic-based insulating material, and a resin material.

According to the present disclosure, there is provided a method of producing an all-solid battery. According to the method, even if pressing is performed on an all-solid battery laminate in which a negative electrode current collector layer includes copper and at least one of a negative electrode active material layer and a solid electrolyte layer includes a sulfide solid electrolyte, the all-solid battery in which a decrease in discharging capacity is prevented and an output and a capacity are improved is obtained.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram showing an example of a state in which, when an all-solid battery laminate is pressed, a laminate is insulated from a press machine in a method of the present disclosure; and

FIG. 2 is a schematic diagram for explaining a state of short circuiting when an all-solid battery laminate is pressed in a method of the related art.

### DETAILED DESCRIPTION OF EMBODIMENTS

A method of producing an all-solid battery of the present disclosure includes pressing a laminate including a negative electrode current collector layer, a negative electrode active material layer, a solid electrolyte layer, and a positive electrode active material layer. In the method of producing an all-solid battery, the negative electrode current collector layer includes copper, at least one of the negative electrode active material layer and the solid electrolyte layer includes a sulfide solid electrolyte, a press machine used for the pressing is an anisotropic press machine, and the laminate is pressed in a state where the laminate is insulated from the press machine.

The inventors studied in detail the relationship between production conditions of an all-solid battery and a discharging capacity of the obtained all-solid battery. As a result, they inferred that a phenomenon in which a discharging capacity of the all-solid battery decreases is caused by the fact that, when an all-solid battery in which a negative electrode current collector layer includes copper and at least one of a negative electrode active material layer and a solid electrolyte layer includes a sulfide solid electrolyte is produced, if a laminate is pressed using an anisotropic press machine, short circuiting occurs between positive and negative electrodes through the press machine, and copper in the negative electrode current collector layer is sulfurized.

Anisotropic pressing refers to a pressing method in which an applied pressure varies according to a direction. As examples of the anisotropic press machine, for example, a surface press machine and a roll press machine are exemplified. In pressing using such a press machine, when a pressure is applied to a laminate in a lamination direction, no pressure is applied in a direction perpendicular to the lamination direction. For example, constant pressing regardless of a direction of an applied pressure such as a cold isotactic pressing (CIP) method is not included in anisotropic pressing in this specification.

In anisotropic pressing, when a laminate is pressed in its lamination direction, no pressure is applied from a direction perpendicular to the lamination direction. Therefore, when an all-solid battery laminate including a plurality of layers with different constituent components is pressed using an anisotropic press machine, there is a difference in the deformation amount in the planar direction of the layers in some cases. Thus, according to a difference in the deformation amount for each layer, a component other than a negative electrode active material layer non-laminating portion in the laminate may come in contact with the press machine. In this case, the positive electrode active material layer is directly in contact with the press machine or in contact with the press machine through a positive electrode current collector layer when there is the positive electrode current collector layer. Since the anisotropic press machine is generally made of a metal and has conductivity, short circuiting occurs between positive and negative electrodes through the press machine in the above case.

The negative electrode current collector layer in the all-solid battery laminate includes a negative electrode active material layer non-laminating portion in many cases in order to form a negative electrode current collection tab through which a plurality of negative electrode current collector layers are electrically connected to each other and connection to an external terminal is possible. The negative electrode active material layer non-laminating portion is a portion which projects in a planar direction of the negative electrode current collector layer and in which no negative electrode active material layer is laminated. The planar direction is a direction along a first surface of the negative electrode current collector layer, and the first surface is a surface perpendicular to a direction in which the negative electrode current collector layer, the negative electrode active material layer, the solid electrolyte layer, and the positive electrode active material layer laminate. When the negative electrode current collector layer includes such a negative electrode active material layer non-laminating portion, if pressing is performed by the anisotropic press machine in order to improve an output and a capacity of the all-solid battery, the negative electrode active material layer non-laminating portion is likely to come in contact with the press machine. That is, when the negative electrode current collector layer in the laminate includes the negative electrode active material layer non-laminating portion that projects in the planar direction, short circuiting is more likely to occur between positive and negative electrodes through the above press machine.

The above phenomenon also occurs when the layers in the laminate have the same area. However, if the anisotropic press machine is used when the laminate includes layers with different sizes in the planar direction, a larger layer is deformed more greatly in the planar direction and is likely to come in contact with the press machine. That is, when the laminate includes layers with different sizes in the planar direction, short circuiting is more likely to occur between positive and negative electrodes through the above press machine. Specifically, the negative electrode current collector layer, the negative electrode active material layer, the solid electrolyte layer, and the positive electrode active material layer respectively include a first surface, a second surface, a third surface, a fourth surface perpendicular to a direction in which pressing is performed by the press machine, an area of the first surface is largest in areas of the first surface, the second surface, the third surface, the fourth surface.

In addition, in particular, when the all-solid battery laminate is pressed using the roll press machine as the anisotropic press machine, short circuiting is more likely to occur between positive and negative electrodes through the press machine. Since pressing using the roll press machine is performed by scanning a linear pressure, in the plane of the laminate, an area in which a pressure is applied and an area in which no pressure is applied always exist together. Therefore, when pressing is performed by the roll press machine, since a difference in the deformation amount in the planar direction for each layer is more likely to occur, short circuiting is more likely to occur between positive and negative electrodes through the press machine.

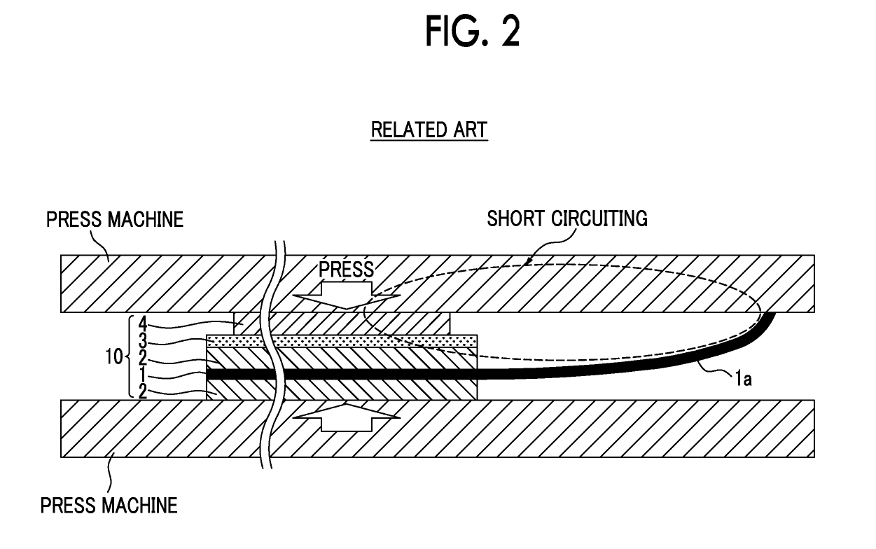

FIG. 2 shows a state in which short circuiting occurs between positive and negative electrodes through the press machine when a laminate 10 including a negative electrode active material layer 2, a negative electrode current collector layer 1 including a negative electrode active material layer non-laminating portion 1a, the negative electrode active material layer 2, a solid electrolyte layer 3, and a positive electrode active material layer 4 in that order is pressed.

When no short circuiting occurs, a negative electrode potential is kept low, and copper in the negative electrode current collector layer is stable. However, when short circuiting occurs between positive and negative electrodes, the negative electrode potential increases and changes to a potential at which copper sulfide is generated. At this potential, copper constituting the negative electrode current collector is eluted as ions, the ions react with sulfur atoms in the sulfide solid electrolyte included in at least one of the negative electrode active material layer and the solid electrolyte layer, and copper sulfide is generated. The presence of copper sulfide is thought to deteriorate a discharging capacity of the all-solid battery.

The generation of copper sulfide due to short circuiting between positive and negative electrodes can also occur in cold pressing at room temperature. However, in heat pressing, a reaction through which copper sulfide is generated is further promoted and a decrease in discharging capacity of the all-solid battery is significant.

In view of the above circumstance, in the present disclosure, in order to prevent generation of copper sulfide due to short circuiting between positive and negative electrodes, when a laminate is pressed during production of an all-solid battery, pressing is performed while a gap between the used press machine and the all-solid battery laminate is insulated.

The insulation between the press machine and the all-solid battery laminate may be performed by, for example, a method in which an insulating material is disposed between the press machine and the all-solid battery laminate.

The insulating material may include at least one of, for example, an oxide-based insulating material, a carbide-based insulating material, a ceramic-based insulating material, and a resin material. The oxide-based insulating material may be, for example, alumina. The carbide-based insulating material may be, for example, silicon carbide. The ceramic-based insulating material may be, for example, a ceramic containing a carbon-based material such as diamond-like carbon. The resin material may be, for example, an imide-based resin and a fluorine-based resin, and typically, a polyimide sheet.

The insulating material can have any shape as long as it can insulate a gap between the press machine and the all-solid battery laminate. The insulating material may have, for example, a sheet form, or may be formed by an appropriate method such as coating on a surface of the press machine that is in contact with the all-solid battery.

In the method of the present disclosure, the laminate subjected to pressing includes a negative electrode current collector layer, a negative electrode active material layer, a solid electrolyte layer, and a positive electrode active material layer. The laminate subjected to pressing may be a laminate that includes a positive electrode active material layer, a solid electrolyte layer, a negative electrode active material layer, a negative electrode current collector layer, a negative electrode active material layer, a solid electrolyte layer, and a positive electrode active material layer in that order.

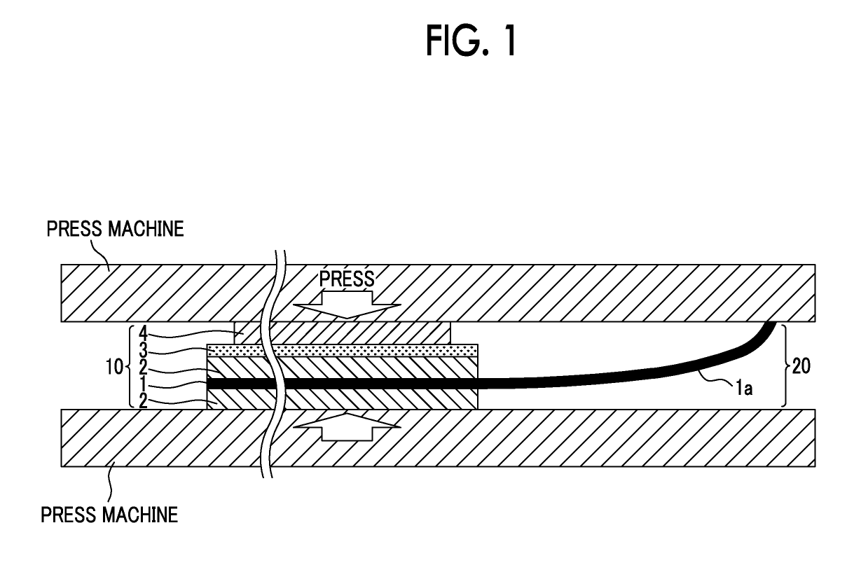

FIG. 1 shows an example of a state in which, when the laminate 10 including the negative electrode active material layer 2, the negative electrode current collector layer 1 including the negative electrode active material layer non-laminating portion 1a, the negative electrode active material layer 2, the solid electrolyte layer 3, and the positive electrode active material layer 4 in that order is pressed, an insulating material 20 is disposed between the press machine and the laminate 10.

The negative electrode current collector layer 1 includes copper. A typical example of the negative electrode current collector layer 1 is a copper foil, a copper alloy foil, or the like.

The negative electrode active material layer 2 includes a negative electrode active material, and may further optionally contain a solid electrolyte, a binder, a conductive additive, and the like.

The negative electrode active material may be selected from among, for example, a silicon material and a carbon material. The silicon material may be, for example, silicon or a silicon alloy. The carbon material may be, for example, natural graphite.

The binder in the negative electrode active material layer 2 may be, for example, butylene rubber, polyvinyl chloride, or styrene butadiene rubber.

The conductive additive in the negative electrode active material layer 2 is preferably, for example, a carbon material. The carbon material may be, for example, vapor grown carbon fibers, acetylene black, Ketjen black, carbon nanotubes, or carbon nanofibers.

The solid electrolyte layer 3 contains a solid electrolyte, and may further optionally contain a binder and the like. The binder used in the solid electrolyte layer 3 may be appropriately selected from among those exemplified above as the binders in the negative electrode active material layer 2.

Thus, at least one of the negative electrode active material layer 2 and the solid electrolyte layer 3 contains a sulfide solid electrolyte. The sulfide solid electrolyte may be selected from among amorphous sulfide solid electrolytes, for example, Li₂S—SiS₂, LiI—Li₂S—SiS₂, LiI—Li₂S—P₂S₅, LiI—Li₂S—P₂O₅, LiI—Li₃PO₄—P₂S₅, and LiI—P₂S₅.

The negative electrode active material layer 2 may include a solid electrolyte other than the sulfide solid electrolyte both when the sulfide solid electrolyte is contained and when no sulfide solid electrolyte is contained.

When the sulfide solid electrolyte is contained, the solid electrolyte layer 3 may further contain a solid electrolyte other than the sulfide solid electrolyte. When no sulfide solid electrolyte is contained, the solid electrolyte layer 3 contains a solid electrolyte other than the sulfide solid electrolyte.

The solid electrolyte other than the sulfide solid electrolyte may be selected from among, for example, an amorphous oxide solid electrolyte, a crystalline oxide solid electrolyte, an oxynitride solid electrolyte, a halide solid electrolyte, and a nitride solid electrolyte. The amorphous oxide solid electrolyte may be, for example, Li₂O—B₂O₃—P₂O₅, or Li₂O—SiO₂. The crystalline oxide solid electrolyte may be, for example, Li₅La₃Ta₂O₁₂, Li₇La₃Zr₂O₁₂, Li₆BaLa₂Ta₂O₁₂, Li_{3.6}Si_{0.6}P_{0.4}O₄, LiNbO₃, Li₄Ti₅O₁₂, or Li₃PO₄. The oxynitride solid electrolyte may be, for example, Li₃PO_{(4-2/3w)}N_{w}(w<1). The halide solid electrolyte may be, for example, LiI. The nitride solid electrolyte may be, for example, Li₃N.

The positive electrode active material layer 4 contains a positive electrode active material and may further optionally contain a solid electrolyte, a binder, a conductive additive, and the like.

The positive electrode active material is not particularly limited as long as the material is used as a positive electrode active material of the lithium ion secondary battery. The positive electrode active material may be, for example, lithium cobaltate (LiCoO₂), lithium nickelate (LiNiO₂), lithium manganite (LiMn₂O₄), LiNi_{1/3}Mn_{1/3}Co_{1/3}O₂, Li₁₊ₓMn_{2-x-y}M_{y}O₄ (M is at least one element selected from among Al, Mg, Co, Fe, Ni, and Zn), lithium titanate (Liₓ/TiO_{y}), or LiMPO₄ (M is at least one element selected from among Fe, Mn, Co, and Ni).

The solid electrolyte, the binder, and the conductive additive used in the positive electrode active material layer 4 may be appropriately selected from among those exemplified above as the solid electrolyte, the binder, and the conductive additive in the negative electrode active material layer 2.

The negative electrode active material layer 2, the solid electrolyte layer 3, and the positive electrode active material layer 4 in the laminate may be formed by applying a mixture prepared as a composition mixture containing a desired component and an appropriate solvent, drying, and forming a film. Such layers may be formed into films directly at predetermined positions in the laminate or may be formed into films on an appropriate substrate and then transferred to desired positions.

The layers in the laminate have sizes (areas of layers) in the planar direction that may be the same or may be different from each other. For example, a laminate in which a large area laminate including the negative electrode active material layer 2, the negative electrode current collector layer 1, the negative electrode active material layer 2, and the solid electrolyte layer 3 in that order and the positive electrode active material layer 4 with a small area are combined may be used.

The press machine used for pressing the laminate is an anisotropic press machine. The anisotropic press machine may be, for example, a surface press machine or a roll press machine.

If the laminate is pressed in a state where the laminate is heated, when short circuiting occurs between positive and negative electrodes, generation of copper sulfide is promoted. Therefore, when the laminate is pressed in a state where the laminate is heated, an effect expected by the present disclosure is exhibited significantly. Heat roll pressing is particularly preferable.

In the laminate pressed under an insulation condition described above, additional layers are further laminated on the laminate as necessary, the laminate is included in an appropriate exterior body, for example, an exterior body made of an aluminum laminate film, and then can be preferably used as the all-solid battery.

### EXAMPLE 1

(1) Preparing a Mixture for Forming a Solid Electrolyte Layer A heptane solution containing heptane and a binder based on butylene rubber with a concentration of 5 mass %, a LiS₂—P₂S₅-based glass ceramic containing LiI particles with an average particle size of 2.5 μm as a sulfide solid electrolyte were put into a container, and stirred and mixed using an ultrasonic dispersion device for 30 seconds to prepare a mixture for forming a solid electrolyte layer.

(2) Preparing a Positive Electrode Mixture

A butyl butyrate solution containing butyl butyrate and a binder based on polyvinylidene fluoride with a concentration of 5 mass %, LiNi_{1/3}Co_{1/3}Mn_{1/3}O₂ particles with an average particle size of 4 μm as a positive electrode active material, a LiS₂—P₂S₅-based glass ceramic containing LiI particles with an average particle size of 0.8 μm as a sulfide solid electrolyte, and vapor grown carbon fibers as a conductive additive were put into a container, and stirred and mixed using a high-speed rotation mixer (product name “FILMIX” commercially available from Primix Corporation) to prepare a positive electrode mixture.

(3) Preparing a Negative Electrode Mixture

A butyl butyrate solution containing butyl butyrate and a binder based on polyvinylidene fluoride with a concentration of 5 mass %, Si particles with an average particle size of 5 μm as a negative electrode active material, and a LiS₂—P₂S₅-based glass ceramic containing LiI particles with an average particle size of 0.8 μm as a sulfide solid electrolyte were put into a container, and stirred and mixed using an ultrasonic dispersion device for 30 seconds to prepare a negative electrode mixture.

(4) Forming a Solid Electrolyte Layer (Producing a Transfer Solid Electrolyte Laminate)

The mixture for forming a solid electrolyte prepared in the above (1) was applied to an aluminum foil as a substrate using a blade method, and then heated on a hot plate whose temperature was adjusted to 100° C. for 30 minutes, and thus a transfer solid electrolyte laminate including the solid electrolyte layer on the aluminum foil was produced.

(5) Forming a Positive Electrode Active Material Layer (Producing a Transfer Positive Electrode Laminate)

The positive electrode mixture prepared in the above (2) was applied to an aluminum foil as a substrate using a blade method and then heated on a hot plate whose temperature was adjusted to 100° C. for 30 minutes, and thus a transfer positive electrode laminate including the positive electrode active material layer on the aluminum foil was produced.

(6) Forming a Negative Electrode Active Material Layer (Producing a Double-Sided Negative Electrode Laminate)

The negative electrode mixture prepared in the above (3) was applied to one surface of a copper foil as a negative electrode current collector using a blade method so that a negative electrode active material layer non-laminating portion projected in the planar direction could be formed, and then heated on a hot plate whose temperature was adjusted to 100° C. for 30 minutes. Next, the negative electrode mixture was applied to the other surface of the copper foil in the same manner using a blade method and then heated on a hot plate whose temperature was adjusted to 100° C. for 30 minutes to produce a double-sided negative electrode laminate including the negative electrode active material layer on both surfaces of the copper foil.

(7) Transferring the Solid Electrolyte Layer and the Positive Electrode Active Material Layer (Producing a Solid Battery Laminate)

The transfer solid electrolyte laminate obtained in the above (4) was laminated on both surfaces of the double-sided negative electrode laminate obtained in the above (6) so that the solid electrolyte layer was in contact with the negative electrode active material layer on both sides and roll pressing was performed at room temperature, the aluminum foil of the substrate was then peeled off, and a laminate including the solid electrolyte layer on both surfaces of the double-sided negative electrode laminate was obtained. The transfer positive electrode laminate obtained in the above (5) was laminated on both surfaces of the laminate so that the positive electrode active material layer was in contact with the solid electrolyte layer on both sides, roll pressing was performed at room temperature, the aluminum foil of the substrate was then peeled off, and a solid battery laminate was obtained. The solid battery laminate was a laminate having a 7-layer structure including the positive electrode active material layer, the solid electrolyte layer, the negative electrode active material layer, the negative electrode current collector layer, the negative electrode active material layer, the solid electrolyte layer, and the positive electrode active material layer in that order.

(8) Roll Pressing

A polyimide sheet was disposed on both surfaces of the solid battery laminate obtained in the above (7), the solid battery laminate was interposed between SUS plates with a thickness of 0.1 mm, heat roll pressing was performed using a roll press machine whose temperature was adjusted to 170° C., and the positive electrode active material layer and the negative electrode active material layer were densified.

(9) Producing All-Solid Battery

The densified solid battery laminate was cut into a predetermined size, and an aluminum foil as the positive electrode current collector layer was laminated on both surfaces. In this case, an end of the aluminum foil was projected in the planar direction of the solid battery laminate and adjusted so that a positive electrode active material layer non-laminating portion could be formed. Next, the active material layer non-laminating portions of the current collector layers of the positive electrode and the negative electrode were connected to external terminals by ultrasonic welding. Then, these were included in an exterior body made of the aluminum laminate while an electrical connection to the outside was possible through the external terminal to produce an all-solid battery.

(10) Evaluation of Battery Performance

Constant current and constant voltage charging was performed on the all-solid batteries produced above to 4.55 V at a current value of 1/10 C at a 10-hour rate. Here, a current value of 1/100 C was set as a termination current. Next, constant current and constant voltage discharging was performed to 2.5 V at a current value of 1/10 C at a 10-hour rate. Here, a current value of 1/100 C was set as a termination current. A ratio of the discharging capacity with respect to the charging capacity in this case was evaluated as an initial charging and discharging efficiency.

### Comparative Example 1

An all-solid battery was produced in the same manner as in Example 1 except that, during (8) roll pressing, no polyimide sheet was disposed on either surface of the solid battery laminate, and the solid battery laminate was directly interposed between SUS plates and heated and roll-pressed, and performance of the battery was evaluated. When the initial charging and discharging efficiency of Example 1 was set to 100, the initial charging and discharging efficiency of the all-solid battery of Comparative Example 1 was 75.

### EXAMPLE 2

An all-solid battery was produced in the same manner as in Example 1 except that, in (3) preparing a negative electrode mixture, graphite particles with an average particle size of 10 μm were used in place of Si particles as the negative electrode active material, and performance of the battery was evaluated. When the initial charging and discharging efficiency of Example 1 was set to 100, the initial charging and discharging efficiency of the all-solid battery of Example 2 was 92.

Comparative Example 2

An all-solid battery was produced in the same manner as in Example 2 except that, during (8) roll pressing, no polyimide sheet was disposed on either surface of the solid battery laminate, and the solid battery laminate was directly interposed between SUS plates and heated and roll-pressed and performance of the battery was evaluated. When the initial charging and discharging efficiency of Example 1 was set to 100, the initial charging and discharging efficiency of the all-solid battery of Comparative Example 2 was 84.

### EXAMPLE 3

An all-solid battery was produced in the same manner as in Example 2 except that, during (8) roll pressing, the temperature of the roll press machine was set to room temperature (25° C.) and cold roll pressing was performed and performance of the battery was evaluated. When the initial charging and discharging efficiency of Example 1 was set to 100, the initial charging and discharging efficiency of the all-solid battery of Example 3 was 101.

### Comparative Example 3

An all-solid battery was produced in the same manner as in Comparative Example 2 except that, during (8) roll pressing, the temperature of the roll press machine was set to room temperature and cold roll pressing was performed, and performance of the battery was evaluated. When the initial charging and discharging efficiency of Example 1 was set to 100, the initial charging and discharging efficiency of the all-solid battery of Comparative Example 3 was 99.

The results of the above examples and comparative examples are summarized in Table 1.

Comparing Example 1 and Comparative Example 1, Example 2 and Comparative Example 2, and Example 3 and Comparative Example 3, respectively, it can be understood that, regardless of the type of the negative electrode active material and the pressing temperature, the initial charging and discharging efficiency was improved by insulating a gap between the laminate and the press machine during pressing. In addition, comparing an improvement amount of the initial charging and discharging efficiency from Comparative Example 2 to Example 2 and an improvement amount of the initial charging and discharging efficiency from Comparative Example 3 to Example 3, it can be understood that an improvement effect of the initial charging and discharging efficiency according to insulation a gap between the laminate and the press machine was significantly stronger than in heat pressing.

TABLE 1

| | | | | | | | Initial |
|---|---|---|---|---|---|---|---|
| | | | Sulfide solid electrolyte | | | | charging |
| | | Negative | Negative | | | | and |
| | Negative | electrode | electrode | | | | discharging |
| | electrode | current | active | Solid | | Insulation | efficiency |
| | active | collector | material | electrolyte | Pressing | during | (relative |
| | material | layer | layer | layer | temperature | press | value) |
| Example 1 | Si | Cu foil | LiI/LiS₂—P₂S₅ | LiI/LiS₂—P₂S₅ | 170° C. | Yes | 100 |
| | | | | | | | (reference) |
| Comparative | Si | Cu foil | LiI/LiS₂—P₂S₅ | LiI/LiS₂—P₂S₅ | 170° C. | No | 75 |
| Example 1 | | | | | | | |
| Example 2 | Graphite | Cu foil | LiI/LiS₂—P₂S₅ | LiI/LiS₂—P₂S₅ | 170° C. | Yes | 92 |
| Comparative | Graphite | Cu foil | LiI/LiS₂—P₂S₅ | LiI/LiS₂—P₂S₅ | 170° C. | No | 84 |
| Example 2 | | | | | | | |
| Example 3 | Graphite | Cu foil | LiI/LiS₂—P₂S₅ | LiI/LiS₂—P₂S₅ | Room | Yes | 101 |
| | | | | | temperature | | |
| Comparative | Graphite | Cu foil | LiI/LiS₂—P₂S₅ | LiI/LiS₂—P₂S₅ | Room | No | 99 |
| Example 3 | | | | | temperature | | |

What is claimed is:

1. A method of producing an all-solid battery, the method comprising
pressing a laminate in a state where the laminate is insulated from a press machine, the laminate including a negative electrode current collector layer, a negative electrode active material layer, a solid electrolyte layer, and a positive electrode active material layer, the negative electrode current collector layer including copper, at least one of the negative electrode active material layer and the solid electrolyte layer including a sulfide solid electrolyte, and the press machine being an anisotropic press machine.

2. The method according to claim 1, wherein the anisotropic press machine configured such that an applied pressure by the press machine varies according to a direction.

3. The method according to claim 1, wherein the negative electrode current collector layer includes a negative electrode active material layer non-laminating portion that projects in a direction along a first surface of the negative electrode current collector layer.

4. The method according to claim 1, wherein the negative electrode current collector layer, the negative electrode active material layer, the solid electrolyte layer, and the positive electrode active material layer respectively include a first surface, a second surface, a third surface, a fourth surface in a direction along the first surface, an area of the first surface is largest in areas of the first surface, the second surface, the third surface, the fourth surface.

5. The method according to claim 1, wherein the press machine is a roll press machine.

6. The method according to claim 1, wherein the press machine is a surface press machine.

7. The method according to claim 1, wherein the laminate is pressed in a state where the laminate is heated.

8. The method according to claim 1, wherein the laminate includes the negative electrode active material layer, the negative electrode current collector layer, the negative electrode active material layer, the solid electrolyte layer, and the positive electrode active material layer in this order.

9. The method according to claim 1, wherein, when the laminate is pressed, an insulating material is disposed between the press machine and the laminate.

10. The method according to claim 9, wherein the insulating material is a sheet.

11. The method according to claim 9, wherein the insulating material is applied to a surface of the press machine that is in contact with the laminate.

12. The method according to claim 9, wherein the insulating material includes at least one of an oxide-based insulating material, a carbide-based insulating material, a ceramic-based insulating material, and a resin material.
